(19) United States
(12) Patent Application Publication
(10) Pub. No.: US 2010/0070959 A1
(43) Pub. Date: Mar. 18, 2010

(54) DYNAMIC IMPROVED EXECUTABLES

(75) Inventors: Ralf Altrichter, Filderstadt (DE); Dirk Heuzeroth, Stuttgart (DE); Gerd Kehrer, Meckenheim (DE); Martin Raitza, Boeblingen (DE)

Correspondence Address: McGinn Intellectual Property Law Group, PLLC, 8321 Old Courthouse Road, Suite 200, Vienna, VA, 22182-3817, US

(73) Assignee: INTERNATIONAL BUSINESS MACHINES CORPORATION, Armonk, NY (US)

(21) Appl. No.: 12/212,076

(22) Filed: Sep. 17, 2008

(51) Int. Cl. G06F 9/45

(52) U.S. Cl. 717/153

(57) ABSTRACT

A method of optimizing a performance of an executable program where the executable program including an executable code portion and a dynamic meta-data portion, the executable code portion and the dynamic meta-data portion being hard-linked together and the dynamic meta-data portion being configured to enhance an operation of the executable code portion. The method includes reading the meta-data. The executable code is then executed while the execution of the executable code is optimized based on the meta-data. Statistical data regarding an operation of the execution of the executable code is collected during the program's run. The dynamic meta-data is updated with the collected statistical data at an ending portion of the executable code.

### BACKGROUND OF THE INVENTION

1. Field of the Invention

The present invention generally relates to a method and apparatus for dynamically optimizing an executable file, and more particularly dynamically optimizing a performance of an executable program having an executable code portion and a dynamic meta-data portion, the executable code portion and the dynamic meta-data portion being hard-linked together.

2. Description of the Related Art

A Java Virtual Machine (JVM) interprets an object code during a program's runtime, allocates memory, and performs other tasks. In order to increase the performance of the JVM, additional information, such as information regarding the behavior of the program to be executed, would be helpful. This information can include statistical data about the typical logical flow of the program. Because this logical flow is the same 90% of the time, and is therefore predictable, this information could lead to an increase in performance using conventional optimization methods.

A JVM is an interpreter that interprets object code during run time. Conventionally, a JVM is optimized by test-running the executable, or program. That is, test runs are executed and statistical data from those test runs are collected. From this test data, a compilation of the source code is optimized. However, in the conventional optimization, this generated executable information is then fixed. That is, it is permanently set, based on the data from the test runs.

In one example of a related, conventional optimization method, U.S. Pat. No. 6,480,862 (incorporated herein by reference) describes a method to organize objects in an object heap based upon access relationships among the data objects (e.g., based upon temporal proximity and/or relative frequencies of access), in order to reduce cache misses and page faults (optimization of object code). The aim of the conventional method is to place objects in the same memory page or cache line respectively when these objects are accessed in a short time range or are accessed frequently. The conventional method could even ensure that garbage collection cycles respect this organization of data objects.

In the conventional method, the information necessary for the placement of the data objects is automatically gathered either during a compiling time or during a runtime, but this information is not stored in the executable itself.

### SUMMARY OF THE INVENTION

In view of the foregoing, and other, exemplary problems, drawbacks, and disadvantages of the conventional systems, it is an exemplary feature of the present invention to dynamically enhance an executable program by updating meta-data each time the program is executed. Exemplarily, a header containing additional meta-information is added to binary or executable files. Exemplarily, in each run of the program, the binary is executed with new, optimized statistical information, and therefore the executable program improves itself with each run.

In view of the foregoing, and other, exemplary problems, drawbacks, and disadvantages of the conventional systems, it is an exemplary feature of the present invention to dynamically enhance an executable program via a method having a program with an executable code portion and a dynamic meta-data portion, the executable code portion and the dynamic meta-data portion being hard-linked together and the dynamic meta-data portion being configured to enhance an operation of the executable code portion, the method including reading the meta-data, executing the executable code, optimizing the execution of the executable code based on the meta-data, collecting statistical data regarding an operation of the execution of the executable code, and updating the dynamic meta-data with the collected statistical data at an ending portion of the executable code.

An additional benefit of the present invention would be that “hints” are provided to interpreters to improve performance of program execution. These hints, or the meta-data, are stored with the executable itself and updated at each run. In addition, the optimized dynamic files are moved with the executable file and therefore the optimized files remain with the execution files.

Another benefit provided by exemplary aspects of the present invention is that the meta-data would be stored in the executable itself and that the meta-data is updated after each run, this means it improves dynamically with each code execution and cumulates the recorded statistical information.

Accordingly, an exemplary method/apparatus to organize data objects (and optimize the performance using standard prior art methods) based upon stored meta-data in the executable file itself (source code/binary instructions for interpreter) is provided.

### BRIEF DESCRIPTION OF THE DRAWINGS

The foregoing and other purposes, aspects and advantages will be better understood from the following detailed description of an exemplary embodiment of the invention with reference to the drawings, in which:

FIG. 1 illustrates an exemplary program file 100;

FIG. 2 illustrates an exemplary method 200 for optimizing an operation of program file 100;

FIG. 3 illustrates another exemplary method 300 for optimizing an operation of another program file;

FIG. 4 schematically illustrates a computing system 400 that reads and writes from the program file 100;

FIG. 5 illustrates a typical hardware configuration 500 which may be used for implementing the method according to the exemplary aspects of the present invention; and

FIG. 6 illustrates a magnetic data storage diskette 600 and CD-ROM 602 to store the method 600.

### DETAILED DESCRIPTION OF EXEMPLARY EMBODIMENT OF THE INVENTION

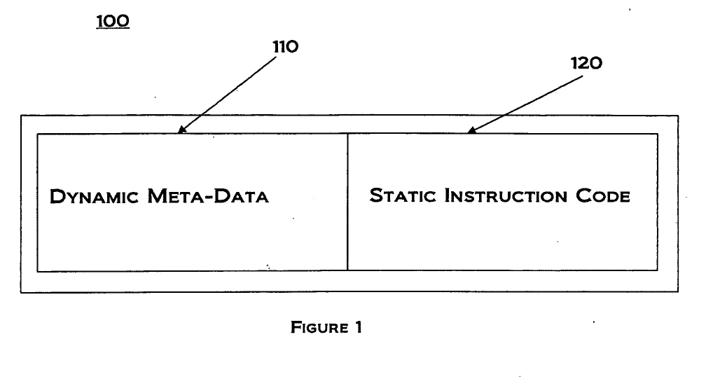

Referring now to the drawings, and more particularly to FIGS. 1-6, there are shown exemplary embodiments of the method and structures according to the present invention.

In an exemplary embodiment of the present invention, a dynamic enhancement of an executable program is provided. Exemplarily, the meta-data of the executable program is enhanced or updated during the runtime of the executable, or program. Additional information that is separate from the program data itself would also be stored with or in the executable. As a result of updating the data, performance will be increased the next time the binary is executed, either as a Java Virtual Machine, or other interpreters.

FIG. 1 is an illustration of an exemplary executable 100. Referring to FIG. 1, executable 100 is a program configured to run or execute in a computer environment. Exemplarily, a header is added to binary files. The header would contain additional meta-data or meta-information such as statistical data collected during a runtime of the executable. This meta-data would be used to increase performance of the executable.

Thus, executable 100 would include two programming portions, meta-data 110 and binary code instructions 120. Meta-data 110 would be used by the interpreter while executing binary code instructions 120 to increase performance of binary code instructions 120. On the other hand, the interpreter would also be collecting statistical data during the runtime to update meta-data 110 after binary code instructions 120 execution, so that the new, updated meta-data 110 contains improved information regarding an operation of binary code instructions 120.

In this manner, meta-data 110 would be exemplarily improved each time binary code instructions 120 are executed with new statistical information. As a result, a performance of executable 100 would be improved with each run. However, binary code instructions 120 would not be modified. Not modifying binary code instructions 120 guarantees that nothing is changed in the program logic itself. Instead, additional information on “how to execute the binary instructions best” is improved over time.

Because meta-data 110 and binary code instructions 120 are stored in the same executable 100, the two are “hard-linked” together and it is possible to distribute executables which are already optimized after being executed and containing some meta-data.

Exemplary embodiments of the present invention would be used for interpreters in general when executing programs. The behavior of the same software can be different in different environments. As a result of the phenomenon, it is not possible to optimize programs for all possible customer scenarios. A program could be optimized for one particular, or special, environment. However, by specializing that program, the specialized program would perform badly in another environment. Exemplary embodiments would allow the executable to be improved and optimized during its runtime and would be able to adapt itself to new environments.

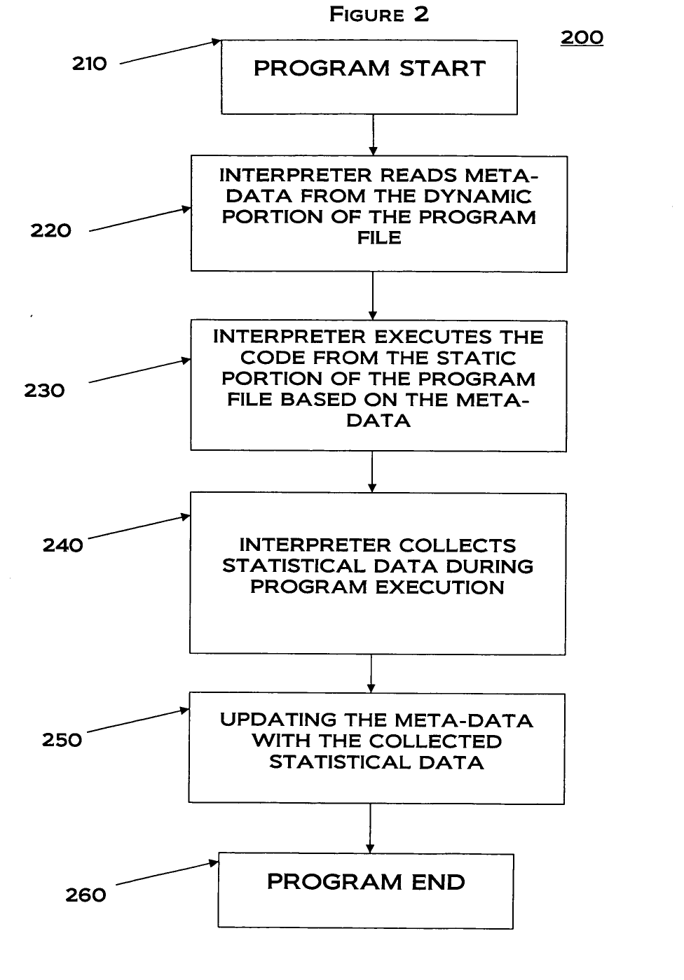

FIG. 2 illustrates an exemplary method 200 for dynamically updating meta-data. Exemplarily, method 200 would be performed for a program file including a dynamic metadata portion and a static instruction code portion, such as the program file 100 illustrated in FIG. 1.

At Step 210 of method 200, the executable program begins. At the start of the execution of the program in Step 210, Step 220 would then exemplarily include reading the meta-data from the dynamic portion of the program file. Exemplarily, in Step 230, an interpreter uses the meta-data to execute the instruction code, such as binary code instructions, to optimize program execution.

During operation of the executable program by the interpreter, Step 240 would exemplarily collect statistical data. This statistical data would then be used in Step 250 to update the meta-data. In addition, in either of Step 230 or Step 250, an optimization program may analyze the statistical data to further refine the program's execution.

Exemplarily, Step 250 would be performed closely before Step 260 ends the program's execution. Thus, performance and optimization information would be analyzed and stored when the program ends its run.

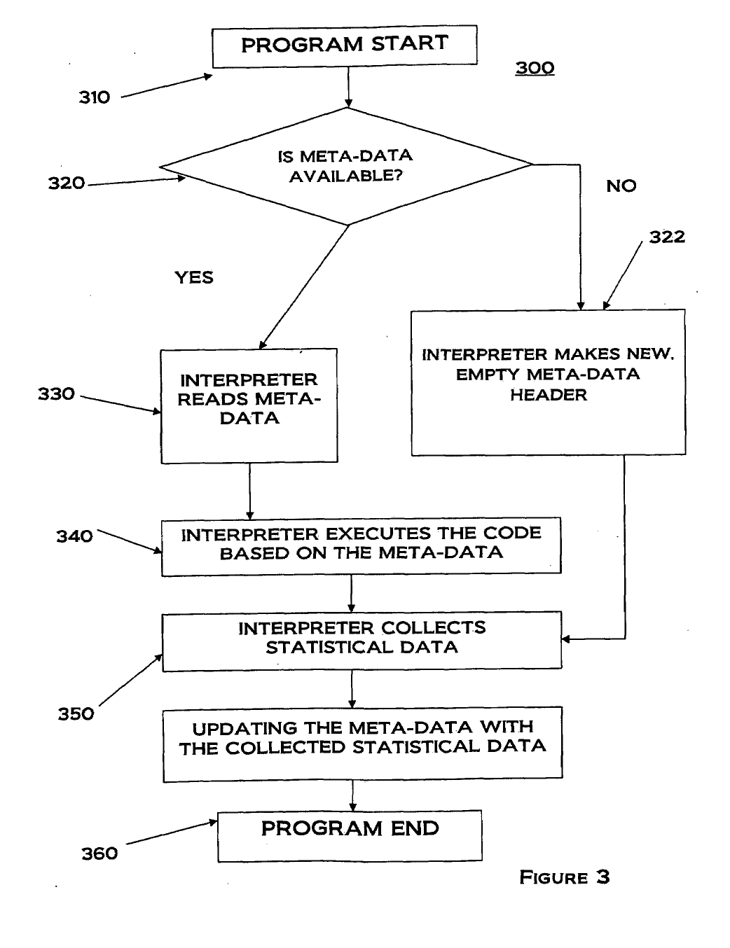

FIG. 3 illustrates another exemplary method 300 for optimizing an operation of another program file. Referring to FIG. 3, method 300 includes starting the program in Step 310. Method 300 then determines whether the program includes a dynamic meta-data file in Step 320.

If Step 320 determines that the program does include the dynamic meta-data file, then method 300 proceeds to Step 330 to read the meta-data. Exemplarily, in Step 340, an interpreter uses the meta-data to execute the instruction code, such as binary code instructions, to optimize program execution.

If Step 320 determines that the program does not include a dynamic meta-data file, then method 300 proceeds to Step 322 to create a new, empty meta-data header to be included in the program file. Therefore, an executable not having an attached meta-data header would be provided with such a header.

Step 330 exemplarily includes reading the meta-data from the dynamic portion of the program file. Exemplarily, in Step 340, an interpreter uses the meta-data to execute the instruction code, such as binary code instructions, to optimize program execution.

After either of Step 322 or Step 340, Step 350 would exemplarily collect statistical data. This statistical data would then be used in Step 360 to update the meta-data.

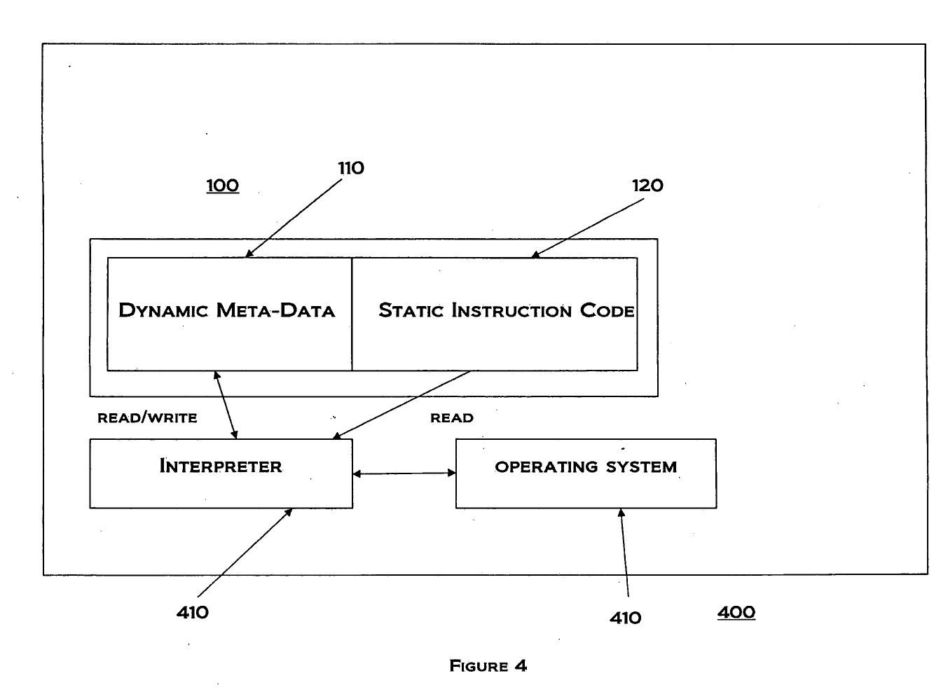

FIG. 4 schematically illustrates a computing system 400 that would read and write from the program file 100, for example. Referring to FIG. 4, computing system 400 would exemplary include an operating system 420 running on computer system 400. On top of operating system 420, interpreter 410 is running. Interpreter 410 readies program file 100 with source code or binary instructions 120 to be executed. As illustrated in FIG. 1, program file 100 exemplarily includes two parts: a header with meta-data 110 and a second part with binary code instructions 120. Interpreter 410 exemplarily would be able to read binary code instructions 120 but not to write to binary code instructions 120, but interpreter 410 would exemplarily be allowed to read and write the meta-data 110.

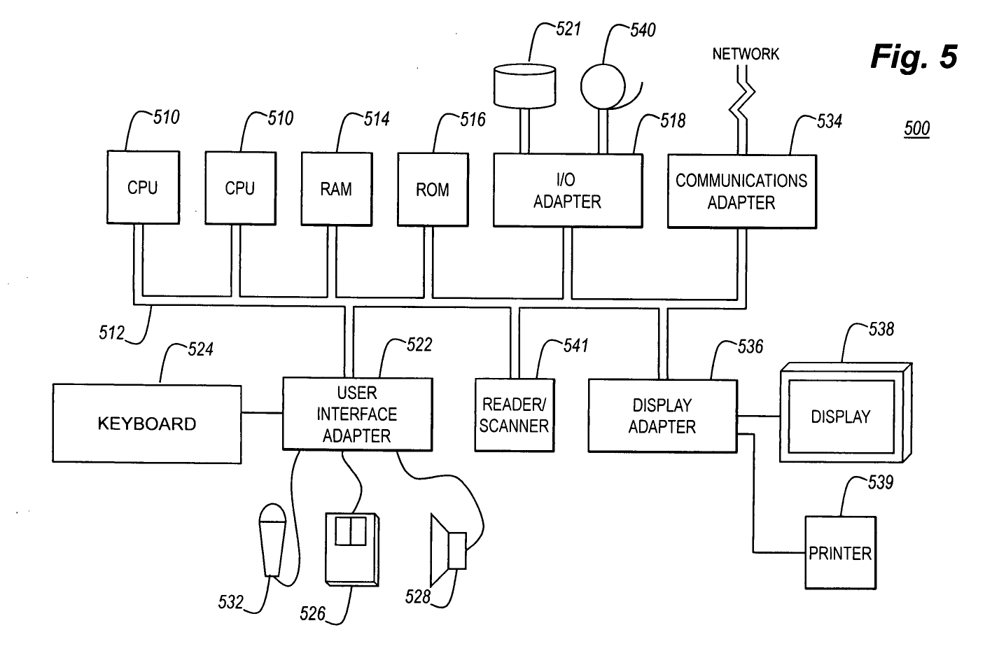

Referring now to FIG. 5, system 500 illustrates a typical hardware configuration which may be used for implementing the inventive system and method for optimizing meta-data. The configuration has preferably at least one processor or central processing unit (CPU) 510. The CPUs 502 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communication adapter 534 for connecting an information handling system to a data processing network, the Internet, and Intranet, a personal area network (PAN), etc., and a display adapter 536 for connecting the bus 512 to a display device 538 and/or printer 539. Further, an automated reader/scanner 541 may be included. Such readers/scanners are commercially available from many sources.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Thus, this aspect of the present invention is directed to a programmed product, comprising signal-bearing media tangibly embodying a program of machine-readable instructions executable by a digital data processor incorporating the CPU 310 and hardware above, to perform the method of the invention.

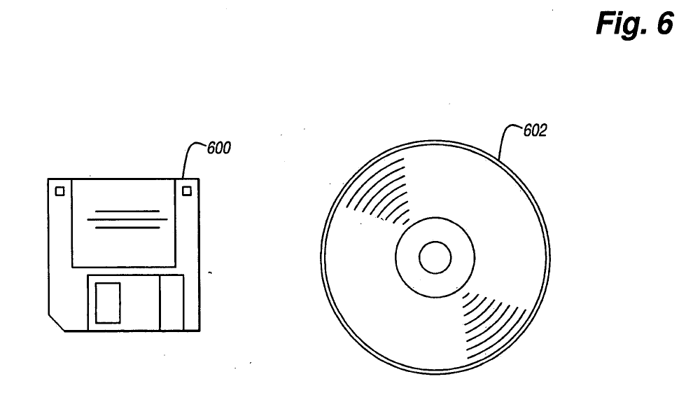

This signal-bearing media may include, for example, a RAM contained within the CPU 510, as represented by the fast-access storage for example. Alternatively, the instructions may be contained in another signal-bearing media, such as a magnetic data storage diskette 600 or CD-ROM 602, (FIG. 6), directly or indirectly accessible by the CPU 510.

Whether contained in the computer server/CPU 510, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C,” etc.

While the invention has been described in terms of exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A method of optimizing a performance of an executable program, the executable program including an executable code portion and a dynamic meta-data portion, the executable code portion and the dynamic meta-data portion being hard-linked together and the dynamic meta-data portion being configured to enhance an operation of the executable code portion, the method comprising:
reading the meta-data;
executing the executable code;
optimizing the execution of the executable code based on the meta-data;
collecting statistical data regarding an operation of the execution of the executable code; and
updating the dynamic meta-data with the collected statistical data at an ending portion of the executable code.
